(19) United States
(12) Patent Application Publication
(10) Pub. No.: US 2026/0066774 A1
(43) Pub. Date: Mar. 5, 2026

(54) BIDIRECTIONAL MULTI-MODE POWER CONVERTER WITH PARASITICS ABSORPTION

(71) Applicant: VIRGINIA TECH INTELLECTUAL PROPERTIES, INC., Blacksburg, VA (US)

(72) Inventors: Aakash Kamalapur, Blacksburg, VA (US); Khai D.T. Ngo, Blacksburg, VA (US)

(21) Appl. No.: 19/317,373

(22) Filed: Sep. 3, 2025

Related U.S. Application Data
(60) Provisional application No. 63/689,979, filed on Sep. 3, 2024.

(51) Int. Cl. H02M 1/34; H02M 1/00; H02M 1/44; H02M 3/00; H02M 3/158

(52) U.S. Cl. CPC H02M 1/346; H02M 1/0064; H02M 1/007; H02M 1/0083; H02M 1/44; H02M 3/003; H02M 3/005; H02M 3/1584

(57) ABSTRACT

An example power converter includes a first switch package and a second switch package for converting a first direct current (DC) voltage to a second DC voltage, where the first switch package and the second switch package are electrically connected between a voltage source and a load. The power converter includes an input inductor electrically connected between the first switch package and the voltage source and an output inductor electrically connected between the second switch package and the load. The power converter further includes a first capacitor package electrically connected between the input inductor and the output inductor, and a second capacitor package electrically connected between the voltage source and the load. The first capacitor package and the second capacitor package are configured to provide dielectric isolation for the power converter.

### CROSS-REFERENCE TO RELATED APPLICATIONS

This application claims the benefit of and priority to U.S. Provisional Patent Application No. 63/689,979, filed Sep. 3, 2024, entitled “BIDIRECTIONAL MULTI-MODE POWER CONVERTER WITH PARASITICS ABSORPTION FOR DIELECTRIC ENERGY TRANSFER, ISOLATION AND INSULATION,” the entire content of which is hereby incorporated herein by reference in its entirety.

### STATEMENT REGARDING FEDERALLY SPONSORED RESEARCH OR DEVELOPMENT

This invention was made with government support under grant number DE-AR0001568, awarded by ARPA-E. The government has certain rights in the invention.

### BACKGROUND

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

Many applications rely upon high-efficiency power converters that provide isolation to the load. Although many topologies are good candidates for this application, isolated Cuk converters can be desirable due to their isolation capabilities, bidirectional power flow, and reduction of electromagnetic interference (EMI).

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts an optimal layout of an input-series output-parallel (ISOP) system with n cells according to various embodiments of the present disclosure.

FIG. 2 depicts an ISOP system, which is a generalized representation of the ISOP system shown in FIG. 1, where connections between cells in the MV and the low voltage (LV) buses are left as ports to signify the manifestation of dimensional parasitics, according to various embodiments of the present disclosure.

FIG. 3 depicts a power converter with split coupling capacitors according to various embodiments of the present disclosure.

FIG. 4 depicts a commutation loop of the power converter shown in FIG. 3 according to various embodiments of the present disclosure.

FIG. 5 depicts an equivalent circuit of the commutation loop shown in FIG. 4 according to various embodiments of the present disclosure.

FIG. 6 depicts a decentralized commutation loop of the power converter shown in FIG. 3 according to various embodiments of the present disclosure.

FIG. 7 depicts an equivalent circuit of the commutation loop shown in FIG. 6 according to various embodiments of the present disclosure.

FIG. 8A depicts a first subinterval operation circuit of the power converter shown in FIG. 3 according to various embodiments of the present disclosure.

FIG. 8B depicts a second subinterval operation circuit of the power converter shown in FIG. 3 according to various embodiments of the present disclosure.

FIG. 8C depicts a third subinterval operation circuit of the power converter shown in FIG. 3 according to various embodiments of the present disclosure.

FIG. 8D depicts a fourth subinterval operation circuit of the power converter shown in FIG. 3 according to various embodiments of the present disclosure.

FIG. 9A depicts a steady-state operation and time evolution diagram of the power converter shown in FIG. 3 with zero-voltage switching (ZVS) according to various embodiments of the present disclosure.

FIG. 9B depicts a state-plane diagram for the second subinterval operation circuit shown in FIG. 8B according to various embodiments of the present disclosure.

FIG. 9C depicts a state-plane diagram for the first subinterval operation circuit shown in FIG. 8A according to various embodiments of the present disclosure.

FIG. 10 depicts a schematic of an example ISOP power converter implementing the power converter shown in FIG. 3 according to various embodiments of the present disclosure.

### DETAILED DESCRIPTION

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications. Many applications rely upon high-efficiency power converters that provide isolation to the load. Although many topologies are good candidates for this application, isolated Cuk converters can be desirable due to their isolation capabilities, bidirectional power flow, and ability to reduce electromagnetic interference (EMI).

The growing demand for medium-voltage (MV) electrical distribution, driven by factors such as the expansion of electric vehicle (EV) charging infrastructure, urbanization-induced real estate constraints, increased reliance on distributed renewable energy, the need for efficient energy storage, and the rising frequency of severe weather events, has led to a significant shift in distribution systems. This shift has progressed from low-frequency transformer (LFT) based systems to power-electronics-based medium-voltage processors, ultimately culminating in the formalized system of solid state transformers (SSTs). SSTs offer notable advantages, including bidirectional power flow control, advanced protection, and diagnostic capabilities. However, as input or output port voltages increase, the non-linear insulation requirements can introduce significant challenges in the design of high-frequency transformers (HFTs) within individual SST cells, reducing the achievable power density to as low as 3.8MW/m³ according to one example.

The limitations discussed above exemplify one aspect of the broader complexity in power electronics design. Another concern is the rise of dimensional parasitics, which are inherent in input-series output-parallel (ISOP) converters, a common architecture in SST designs. These parasitics often manifest as inductive elements in the circuit and play a pivotal role in the design of MV converters. Furthermore, these parasitics can be accompanied by coupling capacitances, which, while contributing to increased common-mode currents, have minimal impact on steady-state converter operation.

As mentioned above, the demand for medium voltage direct current (MVdc) power distribution in land-constrained residential areas has highlighted the need for compact power processors and architectures. High-density power distribution requires copackaging of power passive components and switches to enhance power densities while addressing insulation and thermal management for MV systems. However, such designs inherently introduce parasitics within the converter. In this context, various embodiments of the present disclosure are directed toward absorbing these parasitics as manifestations of non-linear insulation and coaxial structural constraints. The capacitively-isolated Ćuk converter (CIĆC) is relied upon as a high step-down solution for modular converters according to the embodiments.

The CI\ddot{C}C can mitigate parasitics, enabling integration into ISOP architectures, such as solid-state transformers (SSTs). By using the dielectric for both insulation and energy transfer, the CÍCC can eliminate transformer-based cells in SSTs. Additionally, the embodiments can achieve a significant reduction in the blocking capacitor size required for zero-voltage switching (ZVS). The proposed topology according to the embodiments can be validated using a custom-packaged 2 kV-to-400 V, 50 KW coaxial modular converter operating at 100 kHz, achieving a power density of 8 MW/m³. These results demonstrate the CIĆC's potential to address the challenges of high-density, modular MV power conversion.

Therefore, an example embodiment of the present disclosure includes a power converter including a first switch package for converting a first direct current (DC) voltage to a second DC voltage, where the first switch package and the second switch package electrically connected between a voltage source and a load. The power converter also includes an input inductor electrically connected between the first switch package and the voltage source and an output inductor electrically connected between the second switch package and the load. The power converter further includes a first capacitor package electrically connected between the input inductor and the output inductor, and a second capacitor package electrically connected between the voltage source and the load. The first capacitor package and the second capacitor package can be configured to provide dielectric isolation for the power converter.

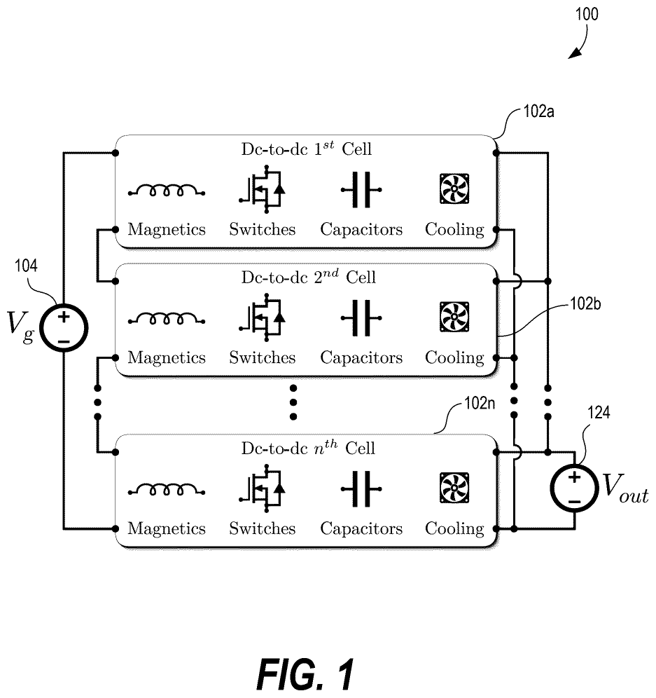

Referring now to the drawings, FIG. 1 depicts an optimal layout of an ISOP system 100 with n cells according to various embodiments of the present disclosure. The ISOP system 100 includes cells ranging from 102a, 102b, to 102n. The cells 102a to 102n are DC-to-DC cells which can each include various components such as magnetics, switches, capacitors and cooling components. The ISOP system 100 assumes that the DC-to-DC stages (e.g., the cells 102a to 102n) are isolated either galvanically or dielectrically. Any number of stages can be cascaded to achieve the desired conversion ratio. Vₒᵤₜ/V_{g} for each cell. However, dimensional parasitics can be present in ISOP systems, such as the ISOP system 100, which many systems and existing solutions do not account for. Therefore, various embodiments of the present disclosure are directed towards absorbing these dimensional parasitics in individual cells of an MV ISOP system, such as applied to the ISOP system 100, while avoiding cascaded DC-to-DC stages to minimize component counts.

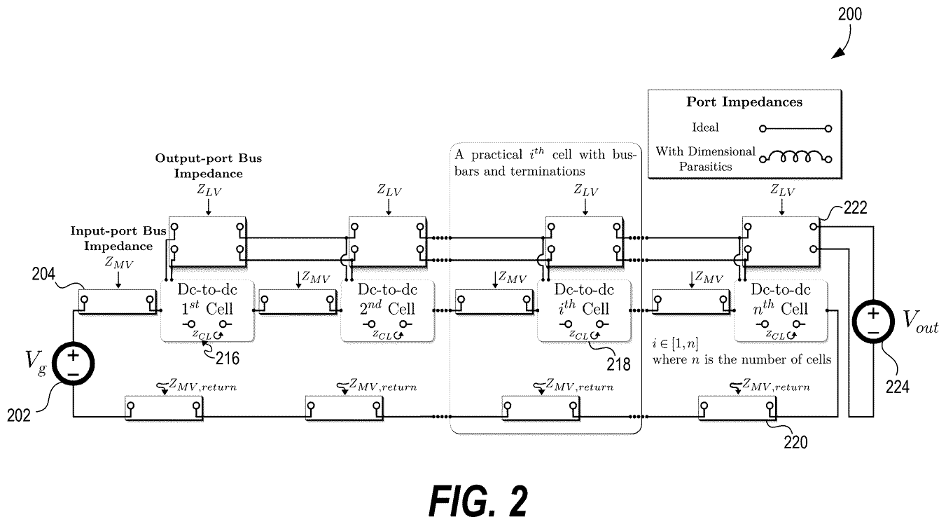

FIG. 2 depicts an ISOP system 200, which is a generalized representation of the ISOP system 100, where the connections between cells in the MV and the low voltage (LV) buses are left as ports to signify the manifestation of dimensional parasitics, according to various embodiments of the present disclosure. The ISOP system 200 signifies the manifestation of dimensional parasitics as applied to the ISOP system 100. Four types of dimensional parasitics can arise as functions of spacing within and between cells, governed by insulation and thermal constraints. These dimensional parasitics are defined as input port bus impedance (Z_{MV}) 204, output port bus impedance (Z_{LV}) 222, input port return impedance (Z_{MV}, return) 220, and commutation loop impedance (Z_{CL}) 216. The input port bus impedance (Z_{MV}) 204, the output port bus impedance (Z_{LV}) 222, the input port return impedance (Z_{MV}, return) 220, and the commutation loop impedance (Z_{CL}) 216 are present between a voltage source 202 and output voltage 224 and can be present for each cell of the ISOP system 200.

The Z_{CL} 216 represents the impedance of a commutation loop within individual DC-to-DC cells of the ISOP system 200. For simplicity in referring to these dimensional parasitics throughout the present disclosure, the grouping of the dimensional parasitics may additionally be referred to as L_{[LV,MV,CL]}, where the Z identifier is replaced with L to denote the inductive nature of the dimensional parasitics. For example, the Z_{MV} 204 may additionally be referred to as the L_{MV} 204, the Z_{LV} 222 may additionally be referred to as the L_{LV} 222, and the Z_{CL} 216 may additionally be referred to as the L_{CL} 216.

As mentioned above, the ISOP system 200 incorporates the dimensional parasitics as port impedances Z_{MV} 204 at the MV port and Z_{LV} 222 at the LV port, representing the impedances in the input and output port connections, respectively. These impedances can depend on the length of the DC-to-DC cells (e.g., as implemented in coaxial power converters or structures), influenced further by insulation and thermal considerations. Additionally, the Z_{MV, return} 220 is a function of the cell length and can be repeated n times, corresponding to the number of cells. The Z_{MV, return} 220, or the input port return impedance or parasitic, has no distinct impact from the Z_{MV} 204, as both are effectively in series. For clarity and to avoid redundancy, the Z_{MV}, return 220 is henceforth considered as part of the Z_{MV}.

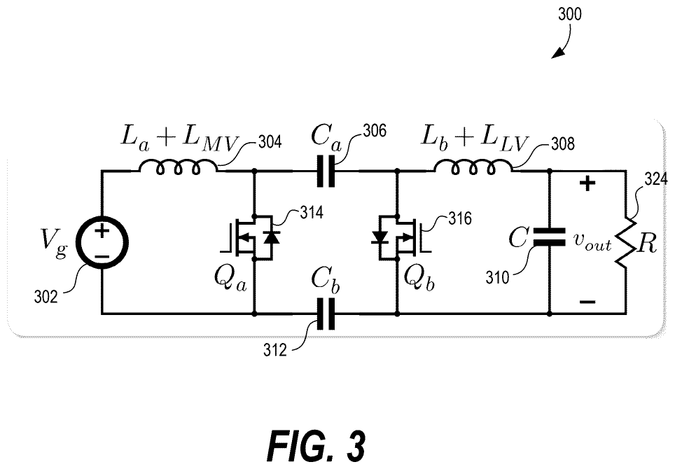

The dimensional parasitics mentioned above can arise due to length and spacing between cells, such as the DC-to-DC cells in the ISOP system 200, which can result from thermal and insulation considerations when positioning them apart. Based on isolation requirements, the dielectric material, typically used as an encapsulant for local insulation within and between cells, can also be utilized for isolation, thereby enabling capacitive isolation and mitigating the dimensional parasitics corresponding to the input port bus impedance Z_{MV} 204, the output port bus impedance Z_{LV} 222, the input port return impedance Z_{MV, return} 220, and the commutation loop impedance Z_{CL} 216. To further mitigate these dimensional parasitics, a Ćuk converter can be relied upon, with the coupling capacitor split into the return path, as is further described and shown with respect to FIG. 3.

FIG. 3 depicts a power converter 300 with split coupling capacitors, according to various embodiments of the present disclosure. The power converter 300 is a CIĆC that can be configured to convert a first DC voltage to a second DC voltage (e.g., corresponding to step down conversion). The power converter 300 includes a voltage source 302, an input inductor 304, a first switch package 314, a first capacitor package 306, a second capacitor package 312, a second switch package 316, an output inductor 308, an output capacitor 310, and a load 324. The power converter 300 is not exhaustively illustrated, meaning that one or more components that are not shown may be relied upon in some cases. Alternatively, one or more components shown in FIG. 3 may be omitted in some cases.

The first switch package 314 and the second switch package 316 are electrically connected between the voltage source 302 and the load 324. The input inductor 304 is electrically connected between the first switch package 314 and the voltage source 302. The output inductor 308 is electrically connected between the second switch package 316 and the load 324. The first capacitor package 306 is electrically connected between the input inductor 304 and the output inductor 308. The second capacitor package 312 is electrically connected between the voltage source and the load, wherein the first capacitor package 306 and the second capacitor package 312 are configured to provide dielectric isolation for the power converter 300.

The first switch package 314 and the second switch package 316 can each include a plurality of dies connected in parallel. For example, the first switch package 314 and the second switch package 316 can each include r=6 dies connected in parallel. In other embodiments, the first switch package 314 and the second switch package 316 can each include greater than or fewer than r=6 dies connected in parallel. Each die or switching transistor in the first switch package 314 and the second switch package 316 can be embodied as insulated-gate bipolar transistors (IGBTs), metal-oxide-semiconductor field-effect transistors (MOSFETs), or other suitable types of switching transistors or active switching devices. Each die or switching transistor in the first switch package 314 and the second switch package 316 can be embodied in wide band gap (WBG) semiconductor materials, such as gallium nitride (GaN) and silicon carbide (SiC), semiconductor materials, as examples, including GaN/SiC power modules. The switch packages 314 and 316 are not limited to any particular type of switching device or devices formed from any particular type of semiconductor materials, however.

The inclusion of split coupling capacitors (e.g., the first capacitor package 306 and the second capacitor package 312) can enable the power converter 300 to achieve dielectric isolation within a power converter system instead of galvanic isolation. This approach leverages the dielectric material commonly used for insulation in transformers to provide complete or near complete solid-state insulation. These modifications can enable the power converter 300 to operate effectively as a cell in an ISOP system, such as the ISOP system 100 or the ISOP system 200. The power converter 300 also enables single stage operation per DC-to-DC cell with capacitive isolation in ISOP systems.

The power converter 300, when implemented in the ISOP system 200, can be configured to reduce or mitigate the dimensional parasitics L_{[LV,MV,CL]}, corresponding to the Z_{MV} 204, Z_{LV} 222, and the Z_{CL} 216, of the ISOP system 200. As discussed above, these impedances can depend on the length of the cell (e.g., the DC-to-DC cells in the ISOP system 200) and the spacing between the cells, influenced by insulation and thermal considerations. To absorb the dimensional parasitics. However, the power converter 300 may not be suitable for ISOP integrations as a single cell in certain instances.

One approach involves absorbing the dimensional parasitics such as the L_{MV} 204 and L_{LV} 222 into energy storage elements and splitting the coupling capacitor into the two coupling capacitor packages 306 and 312 as shown in FIG. 3, for solid-state insulation. The dielectric in the capacitor packages 306 and 312 can facilitate energy transfer during steady state operation while also providing high voltage insulation. This modification compared to other works results in a fully solid state DC-to-DC converter optimized for the first two dimensional parasitics, the L_{MV} 204 and the L_{LV} 222, reducing potential energy losses and mitigating increased switch stresses seen in basic converter topologies such as buck, boost, or even buck-boost, while improving efficiency.

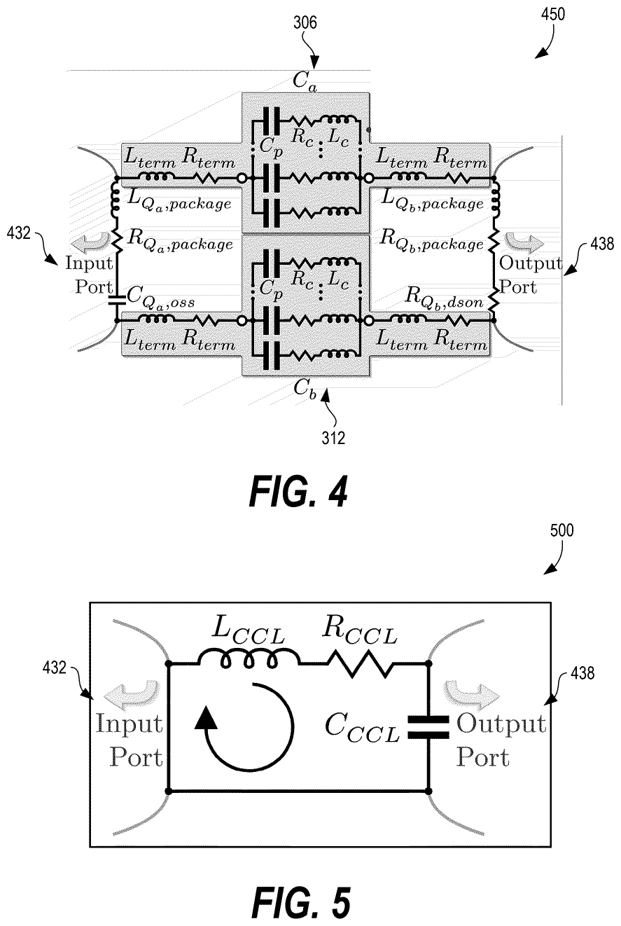

FIG. 4 depicts a commutation loop 450 of the power converter 300, and FIG. 5 depicts an equivalent circuit 500 of the commutation loop 450, according to various embodiments of the present disclosure. The commutation loop 450 can be relied upon, particularly for MV applications, and can correspond to the condition when the second switch package 316 (corresponding to the synchronous rectifier Q_{b}) turns on at high current, causing ringing and voltage spikes. In Ćuk converters, the first and the second capacitor packages 306 and 312 (corresponding to the capacitors Cₐ and C_{b}) typically exhibit a large equivalent series inductance (ESL) exceeding 100 nH, which significantly contributes to this ringing.

The commutation loop 450 can be defined as the loop that includes the first capacitor package 306, the second switch package 316, the second capacitor package 312, and the first switch package 314, and the electrical connection and current flow between these components. The commutation loop 450 includes one or a single commutation loop cell including the connection of the first capacitor package 306, the second switch package 316, the second capacitor package 312, and the first switch package 314. The capacitor packages 306 and 312 in the commutation loop 450 can each include q=30 capacitors Cₚ connected in parallel, with individual equivalent series resistance (ESR) R_{c} and ESL L_{c}. That is, the single commutation loop cell of the commutation loop 450 can include all 30 Cₚ of the first capacitor package 306 and all 30 Cₚ of the second capacitor package 312.

The capacitor packages 306 and 312 are connected between input port 432 and output port 438, which correspond to the ports of the power converter 300 including the first switch package 314 and the second switch package 316, respectively. It should be noted that in other embodiments, the capacitor packages 306 and 312 may include greater than or fewer than 30 capacitors Cₚ connected in parallel, and the commutation loop cell of the commutation loop 450 would include the amount of capacitors Cₚ contained in the capacitor packages 306 and 312.

Additionally, termination inductances Lₜₑᵣₘ and termination resistances Rₜₑᵣₘ can exist at either end of the commutation loop 450, as depicted. The first switch package 314 corresponding to the active switch Qₐ and the second switch package 316 corresponding to the synchronous rectifier Q_{b} include drain and source inductances L_{Q}_{_{a, package}}, L_{Q}_{_{b, package}}, and corresponding resistances RQ_{a, package} and R_{Q}_{_{b, package}} In the example shown, each switch package 314 and 316 includes r=6 dies connected in parallel. While the DC resistances of terminations and packages are typically small (less than 1 mΩ) and negligible relative to the on-resistance of the switches, their AC resistances can be considerably higher due to skin and proximity effects at high frequencies.

The equivalent commutation loop impedances of the commutation loop 450 can be derived as follows, as represented by the equivalent circuit 500:

$${L}_{CCL} {=}^{△} {L}_{t e r m} + \frac{2 {L}_{c}}{q} + \frac{{L}_{{Q}_{a} , package} + {L}_{{Q}_{b} , package}}{r} \qquad ( 1 )$$

$${R}_{CCL} {=}^{△} 4 {R}_{t e r m} + \frac{2 {R}_{c}}{q} + \frac{{R}_{{Q}_{a} , package} + {R}_{{Q}_{b} package} + {R}_{{Q}_{b} , dson}}{r} \qquad ( 2 )$$

$${R}_{CCL} {=}^{△} \frac{r {C}_{{Q}_{a , oss}} + \frac{{qC}_{p}}{2}}{r {C}_{{Q}_{a , oss}} + \frac{{qC}_{p}}{2}} \qquad ( 3 )$$

$${R}_{CCL} {=}^{△} \frac{1}{2 π \sqrt{{L}_{C C L} {C}_{C C L}}} \qquad ( 4 )$$

The values of these parameters are L_{CCL}=82 nH, C_{CCL}=1.19 nF, and R_{CCL}=25 mΩ according to one example. For the R_{CCL} the AC resistances of the package and terminations are considered at the resonant frequency f_{CCL}.

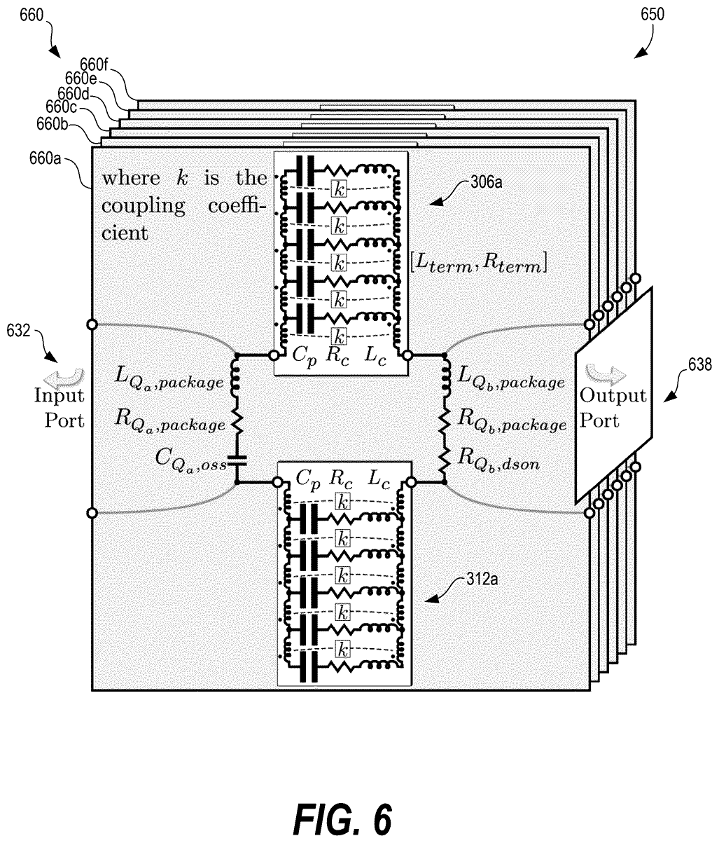

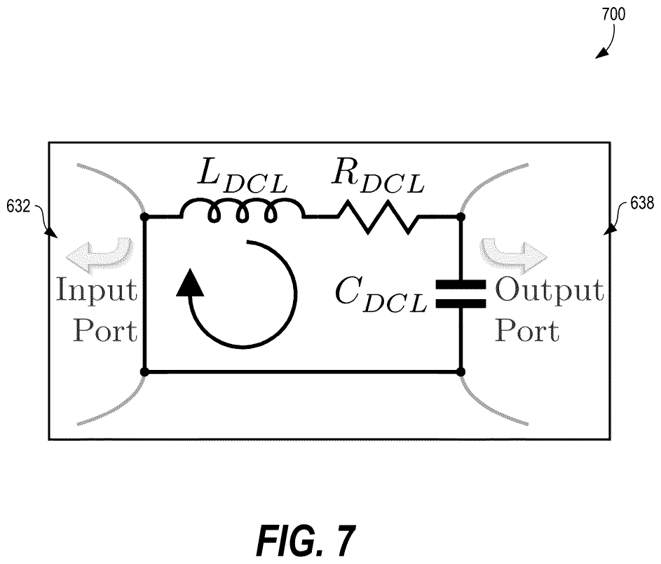

FIG. 6 depicts a commutation loop 650 of the power converter 300, and FIG. 7 depicts an equivalent circuit 700 of the commutation loop 650, according to various embodiments of the present disclosure. The commutation loop 650 is a decentralized commutation loop including a plurality of commutation loop cells 660 connected in parallel with each other via an input port 632 and an output port 638. The input port 632 and the output port 638 correspond to the ports of the power converter 300 (see FIG. 3) including the first switch package 314 and the second switch package 316, respectively.

The plurality of commutation loop cells 660 includes a commutation loop cell 660a, a commutation loop cell 660b, a commutation loop cell 660c, a commutation loop cell 660d, a commutation loop cell 660e, and a commutation loop cell 650f, for a total of six commutation loop cells. The commutation loop 650, however, is not limited to six commutation loop cells and can include greater than or fewer than six commutation loop cells depending on the application of the power converter 300 and the commutation loop 650.

Each of the plurality of commutation loop cells 660 includes a subset of the Cₚ of the first capacitor package 306 and the second capacitor package 312. For example, the commutation loop cell 660a includes a subset 306a of the first capacitor package 306 and a subset 312a of the second capacitor package 312. Assuming that each of the capacitor packages 306 and 312 includes 30 Cₚ, each subset of the capacitor packages 306 and 312 would include five (5) Cₚ for a single commutation loop cell of the plurality of commutation loop cells 660. As such, the subset 306a includes five Cₚ of the first capacitor package 306 connected in parallel, and the subset 312a includes five Cₚ of the second capacitor package 312 connected in parallel, between the input port 632 and the output port 638. Each of the subsets of the plurality of commutation loop cells 660 are connected in parallel with each other via the input port 632 and the output port 638.

The switch packages 314 and 316 are also decentralized and split across the plurality of commutation loop cells 660. Assuming that each of the switch packages 314 and 316 includes six dies, each commutation loop cell (e.g., the commutation loop cell 660a) would include one die or switching transistor for each of the switch packages 314 and 316. For example, in the commutation loop cell 660a, the subset 306a and the subset 312a would be connected to a first die of the switch package 314 and a first die of the switch package 316. As compared to the commutation loop 450, the commutation loop 650 can achieve a lower loop inductance L_{CCL} when implemented in an ISOP system.

The equivalent loop impedances of the commutation loop 650, as illustrated by the equivalent circuit 700, are as follows:

$${L}_{D C L} {=}^{△} \frac{2 {L}_{e q} + {L}_{{Q}_{a , package}} + {L}_{{Q}_{b , package}}}{r} \qquad ( 5 )$$

$${R}_{D C L} {=}^{△} \frac{2 {R}_{e q} + {R}_{{Q}_{a , package}} + {R}_{{Q}_{b , package}} + {R}_{{Q}_{b , dson}}}{r} \qquad ( 6 )$$

$${C}_{D C L} {=}^{△} r \frac{{C}_{{Q}_{a . oss}} \frac{{uC}_{p}}{2}}{{C}_{{Q}_{a o s s}} + \frac{{uC}_{p}}{2}} \qquad ( 7 )$$

$${f}_{DCL} {=}^{△} \frac{1}{2 π \sqrt{{L}_{D C L} {C}_{D C L}}} , \qquad ( 8 )$$

where u=5 is the number of Cₚ in parallel in one commutation-loop stack. The effective inductance L_{eq} and resistance R_{eq} at high frequencies can be determined by shorting the Cₚ and calculating the resulting impedances. The values of these parameters are L_{DCL}=3.5 nH, C_{DCL}=1.19 nF, and R_{DCL}=25 mΩ, with a resonant frequency of the decentralized commutation loop f_{DCL}=78 MHz, according to one example. Various tests and examples show that decentralizing commutation loops, such as in the commutation loop 650, can significantly reduce voltage stress.

The power converter 300 can be configured to absorb the L_{MV} 204 and the L_{LV} 222 via the input inductor 304 and the output inductor 308, respectively (see FIG. 3) during operation of the power converter 300. The addition of the second capacitor package 312, as compared to a single capacitor package, can further provide capacitive and/or dielectric isolation for the power converter 300 during operation, allowing the power converter 300 to operate effectively as a cell in various ISOP systems.

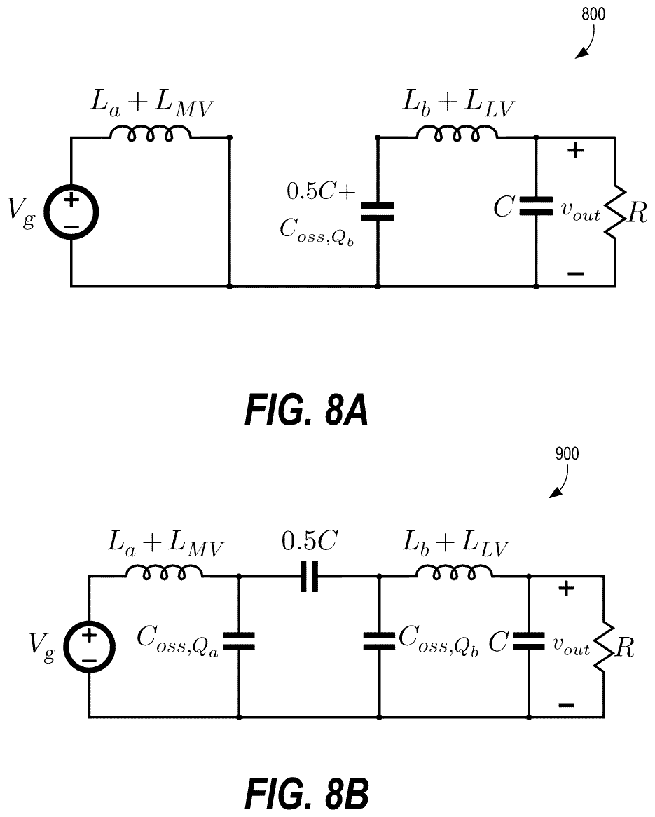

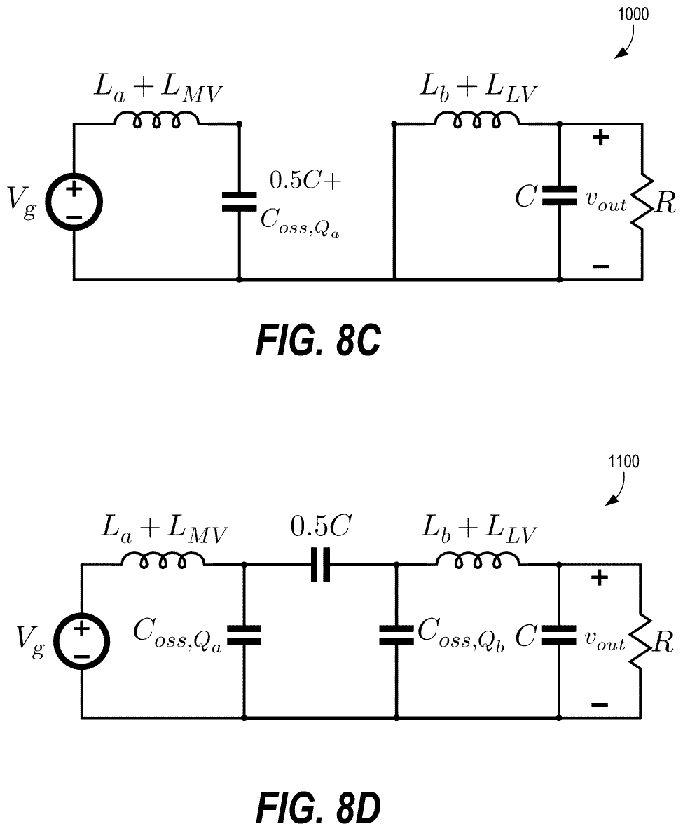

FIG. 8A depicts a first subinterval operation circuit 800 of the power converter 300, FIG. 8B depicts a second subinterval operation circuit 900 of the power converter 300, FIG. 8C depicts a third subinterval operation circuit 1000 of the power converter 300, and FIG. 8D depicts a fourth subinterval operation circuit 1100 of the power converter 300, according to various embodiments of the present disclosure. The power converter 300 can be configured to operate in four subintervals, each represented by the subinterval operation circuits 800-1100. The first subinterval operation circuit 800 corresponds to power inversion operation of the power converter 300, the second subinterval operation circuit 900 corresponds to soft-switching operation of the power converter 300, the third subinterval operation circuit 1000 corresponds to synchronous rectification of the power converter 300, and the fourth subinterval operation circuit 1100 corresponds again to soft-switching of the power converter 300. Accordingly, power inversion and rectification occurs during subintervals defined by the circuits 800 and 1000, while ZVS can be achieved during subintervals defined by the circuits 900 and 1100.

The capacitor packages 306 and 312 (corresponding to the capacitors Cₐ and C_{b}) can have identical capacitances or values C, and the output capacitances of the switch packages 314 and 316 (corresponding to the switches Qₐ and Q_{b}) can be assumed to be identical, thus denoted as C_{oss, Q}_{ₐ}=C_{oss, Q}_{_{b}}=Cₒₛₛ for the circuits 800-1100. The dynamics of the power converter 300 can be described using three families of normalization equations: power inversion (10), soft-switching (11), and power rectification (12), which are normalized with (9), as follows:

$${V}_{base} {V}_{g} \frac{{V}_{out}}{{V}_{g}} \qquad ( 9 )$$

$${ω}_{o , in} {=}^{△} \frac{1}{\sqrt{{L}_{a} ( 0.5 C + {C}_{oss} )}}$$

$${R}_{o , in} {=}^{△} \frac{{L}_{a}}{0.5 C + {C}_{o s s}} \\ {I}_{base , in} {=}^{△} \frac{{V}_{b a s e}}{{R}_{o , in}} \\ {ω}_{o , ss} {=}^{△} \frac{1}{\sqrt{2 ( {L}_{a} \vert \vert {L}_{b} ) {C}_{o s s}}} \qquad ( 10 )$$

$${R}_{o , s s} {=}^{△} \sqrt{\frac{( {L}_{a} \vert \vert {L}_{b} )}{2 {C}_{o s s}}} \\ {I}_{b ase , ss} {=}^{△} \frac{{V}_{b a s e}}{{R}_{o , ss}} \\ {ω}_{o , out} {=}^{△} \frac{1}{\sqrt{{L}_{b} ( 0.5 C + {C}_{oss} )}} \qquad ( 11 )$$

$${R}_{o , out} {=}^{△} \sqrt{\frac{{L}_{b}}{0.5 C + {C}_{o s s}}} \\ {I}_{base , out} {=}^{△} \frac{{V}_{b a s e}}{{R}_{o , out}} \qquad ( 12 )$$

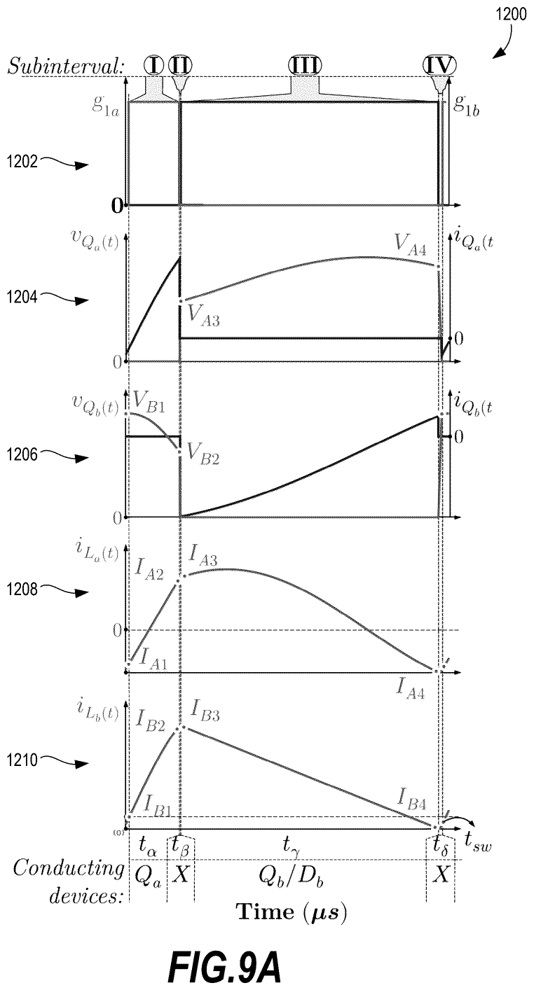

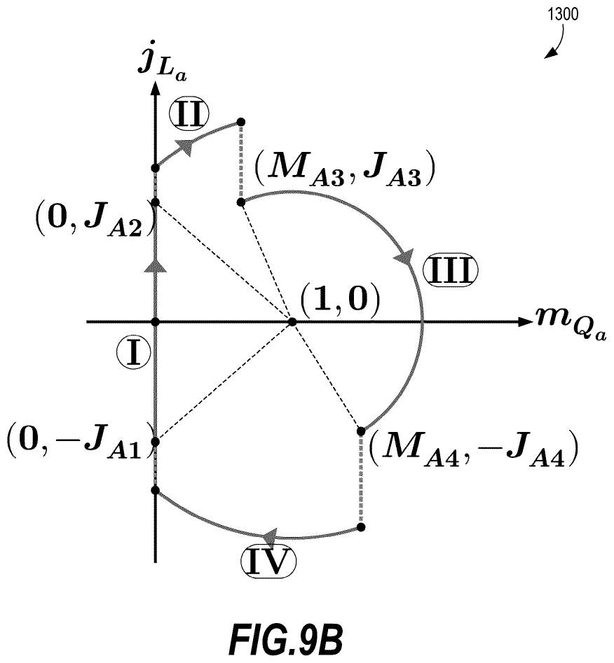

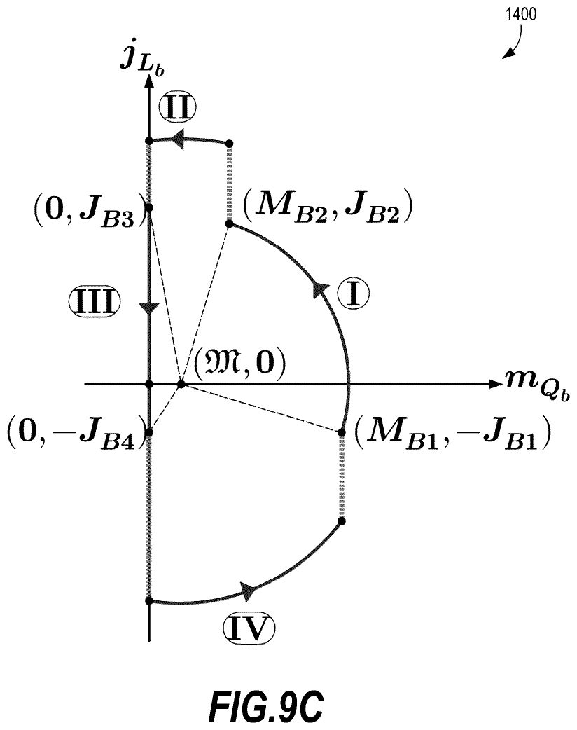

FIG. 9A depicts a steady-state operation and time evolution diagram 1200 of the power converter 300 with ZVS, FIG. 9B depicts a state-plane diagram 1300 for the second subinterval operation circuit 900, and FIG. 9C depicts a state-plane diagram 1400 for the first subinterval operation circuit 800, according to various embodiments of the present disclosure. The steady-state operation diagram 1200 includes five rows 1202, 1204, 1206, 1208, and 1210. The first row 1202 illustrates the gating signals g₁ₐ and g_{1b} for the switches Qₐ and Q_{b}, the second and the third rows 1204 and 1206 illustrate the blocking voltages and conduction currents of Qₐ and Q_{b}, respectively, and the fourth and the fifth rows 1208 and 1210 illustrate the inductor currents i_{L}_{ₐ}(t) and i_{L}_{_{b}}(t), respectively. The input and output inductors (e.g., the input inductor 304 and the output inductor 308) can be configured to resonate with 0.5C+C_{oss,Q}_{_{b}} and 0.5C+C_{oss,Q}_{ₐ} during the inversion and rectification subintervals (I) and (III), enabling soft-switching in the subintervals (II) and (IV). The input and output ports of the power converter 300 can be represented with the state-plane diagrams 1300 and 1400, respectively, and normalized using equations (9) and (12).

For the first subinterval (tₐ) corresponding to the first subinterval operation circuit 800, the first switch package 312 (corresponding to the active switch Qₐ) is turned on, while the second switch package 316 (corresponding to the synchronous rectifier Q_{b}) remains off until the duty or control signal is deactivated. The input port of the power converter 300 can exhibit a linear increase in current i_{L}_{ₐ}(t), while the output port can resonate between L_{b} and 0.5C+Cₒₛₛ, leading to resonances in v_{Q}_{_{b}}(t) and i_{L}_{_{b}}(t) with a dc bias of Vₒᵤₜ. The state-plane diagram 1400 provides the timing tₐ and voltage stress V_{Q}_{_{b,pk}}, derived using (13) and (14), respectively, as follows:

$${t}_{α} = D {t}_{s w} = ( π - arctan ( \frac{{M}_{B 1} -}{{J}_{b 1}} ) - arctan ( \frac{{M}_{B 2} -}{{J}_{B 2}} ) ) {ω}_{o , out} \qquad ( 13 )$$

$${V}_{{Q}_{1 b , pk}} = ( \sqrt{{( {M}_{B 1} - )}^{2} + {J}_{B 2}^{2}} + ) {V}_{b a s e} \qquad ( 14 )$$

For the second subinterval (t_{β}) corresponding to the second subinterval operation circuit 900, the power converter 300 enters a deadband where the stored energy in both of the inductors 304 and 308 discharges the equivalent Cₒₛₛ, enabling ZVS for Q_{1b}. The state-plane diagram 1300 for subinterval-II provides the timing t_{β}, determined using equation (15) as follows:

$${t}_{β} = ( arctan ( \frac{1}{{J}_{A 2} \frac{{R}_{o , ss}}{{R}_{o , in}} + {J}_{B 2} \frac{{R}_{o , ss}}{{R}_{o , out}}} ) + arctan ( \frac{{M}_{A 3} - 1}{{J}_{A 3} \frac{{R}_{o , ss}}{{R}_{o , in}} + {J}_{B 3} \frac{{R}_{o , ss}}{{R}_{o , out}}} ) ) {ω}_{o , ss} \qquad ( 15 )$$

The third subinterval involves synchronous rectification, where the active switch Q_{b} remains off for a period t_{γ} while the synchronous rectifier Q_{b} is on, continuing until nearly the end of the switching period t_{sw} (see FIG. 9A). The output port of the power converter 300 experiences a linear increase in current i_{sw} (t), while the input port of the power converter 300 resonates between Lₐ and 0.5C+Cₒₛₛ, resulting in v_{Q}_{ₐ}(t) and i_{L}_{ₐ}(t) exhibiting resonances with a dc bias of V_{g}. The state-plane diagram for subinterval-III (see FIG. 9B) provides the timing t_{γ} and the voltage stress V_{Q}_{_{1a,pk}} according to equations (16) and (17) as provided below:

$${t}_{γ} = ( π - arctan ( \frac{{M}_{A 4} - 1}{{J}_{a 4}} ) - arctan ( \frac{{M}_{A 3} - 1}{{J}_{A 3}} ) ) {ω}_{o , i n} \qquad ( 16 )$$

$${V}_{{Q}_{1 ap , k}} = ( \sqrt{{( {M}_{A 4} - 1 )}^{2} + {J}_{A 4}^{2}} + 1 ) {V}_{b a s e} \qquad ( 17 )$$

In the fourth subinterval, the power converter 300 enters a deadband where the stored energy in the inductors 304 and 308 discharges the equivalent Cₒₛₛ, enabling ZVS for Qₐ. The state-plane diagram 1400 provides the timing t_{δ} as given in equation (18), provided below:

$${t}_{δ} = ( arctan ( \frac{{J}_{B 4} \frac{{R}_{o , ss}}{{R}_{o , out}} + {J}_{A 4} \frac{{R}_{o , ss}}{{R}_{o , in}}}{} ) + arctan ( \frac{{M}_{B 1} -}{{J}_{A 1} \frac{{R}_{o , ss}}{{R}_{o , in}} + {J}_{B 1} \frac{{R}_{o , ss}}{{R}_{o , out}}} ) ) {ω}_{o , s s} \qquad ( 18 )$$

The equations (9)-(18), combined with simulations, can be utilized to guide the component design of a coaxial modular converter cells rated for 2 kV—to—400 V and up to 50 kW according to some implementations. Notably, the CIĆC such as the power converter 300 shares key features with stacked active bridge converters, but also includes unique bridgeless configurations, characterized by fewer switches, which enhances both efficiency and reliability.

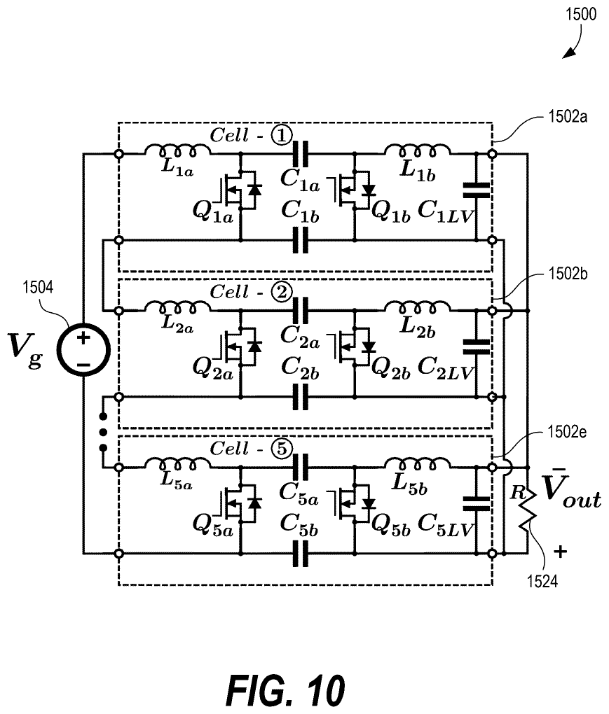

FIG. 10 depicts a schematic of an example power converter 1500 implementing the power converter 300, according to various embodiments of the present disclosure. The power converter 1500 is a Ćuk converter employing an ISOP configuration. More particularly, the power converter 1500 is an isolated-stacked Ćuk (iSCuk) converter employing an ISOP configuration. The power converter 1500 includes five cells 1502a, 1502b, and through 1502e, connected between an input voltage source 1504 and a load 1524, although greater or fewer than five cells can be relied upon depending on the application of the power converter 1500. The power converter 1500 is not exhaustively illustrated, meaning that one or more components that are not shown may be relied upon in some cases. Alternatively, one or more components shown in FIG. 3 may be omitted in some cases. The power converter 1500 can facilitate AC-DC, DC-DC, DC-AC and AC-AC conversion in various power converter systems for a wide range of voltages for medium and high voltage applications. The power converter 1500 is a bidirectional power converter supporting step-down power conversion.

The plurality of cells (e.g., the cell 1502a, 1502b, etc.) of the power converter 1500 each correspond with the CIĆC (corresponding to the power converter 300) and are connected in an ISOP configuration. For example, input ports of each individual cell of the plurality of cells are electrically connected in series, and output ports of each individual cell of the plurality of cells are electrically connected in parallel. The ISOP configuration of the power converter 1500 allows the assembly of the converter stages of the power converter 1500 into multiple individual cells and promotes low-frequency power transmission between the cells' input ports. Consequently, this configuration allows avoidance or omission of high-frequency AC transmission, thus precluding or mitigating ringing of parasitics and increasing of device stress.

The impact of dimensional parasitics is critical in the design of high step-down medium-voltage power processors and has been carefully incorporated into the development of the power converter 300. Building on the design methodology to absorb dimensional parasitics and the analysis of the CIĆC corresponding to the power converter 300, future research may focus on further improving efficiency through the integration of advanced coaxial custom switches and passive components. While the power converter 300 effectively absorbs these parasitics, the power converter 300 may have small signal control to output voltage response, which may exhibit fourth-order dynamics, posing stability challenges that are currently under investigation.

The features, structures, and components described above may be combined in one or more embodiments in any suitable manner, and the features discussed in the various embodiments are interchangeable, where technically suitable. In the foregoing description, certain details provided convey the concepts of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although relative terms such as “on,” “below,” “upper,” “lower,” “top,” “bottom,” “right,” and “left” may be used to describe the relative spatial relationships of certain structural features, these terms are used for convenience only, as a direction in the examples. It should be understood that if the device is turned upside down, the “upper” component will become a “lower” component. When a structure or feature is described as being “over” (or formed over) another structure or feature, the structure can be positioned over the other structure, with or without other structures or features intervening between them. When two components are described as being “coupled to” each other, the components can be electrically coupled to each other, with or without other components being electrically coupled and intervening between them. When two components are described as being “directly coupled to” each other, the components can be electrically coupled to each other, without other components being electrically coupled between them.

Terms such as “a,” “an,” “the,” and “said” are used to indicate the presence of one or more elements and components. The terms “comprise,” “include,” “have,” “contain,” and their variants are used to be open ended and may include or encompass additional elements, components, etc., in addition to the listed elements, components, etc., unless otherwise specified.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASMER) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

1. A power converter, comprising;
a first switch package and a second switch package for converting a first direct current (DC) voltage to a second DC voltage, the first switch package and the second switch package electrically connected between a voltage source and a load;
an input inductor electrically connected between the first switch package and the voltage source and an output inductor electrically connected between the second switch package and the load;
a first capacitor package electrically connected between the input inductor and the output inductor; and
a second capacitor package electrically connected between the voltage source and the load, wherein the first capacitor package and the second capacitor package are configured to provide dielectric isolation for the power converter.

2. The power converter of claim 1, wherein:
the input inductor is configured to absorb an input-port bus impedance during operation of the power converter; and
the output inductor is configured to absorb an output-port bus impedance during operation of the power converter.

3. The power converter of claim 1 wherein:
the first capacitor package comprises a first plurality of capacitors connected in parallel; and
the second capacitor package comprises a second plurality of capacitors connected in parallel.

4. The power converter of claim 3, wherein a commutation loop of the power converter comprises an electrical connection between the first capacitor package, the second capacitor package, the first switch package, and the second switch package.

5. The power converter of claim 4, wherein the commutation loop comprises a single commutation loop cell.

6. The power converter of claim 5, wherein the single commutation loop cell comprises:
the first plurality of capacitors connected in parallel between the first switch package and the second switch package; and
the second plurality of capacitors connected in parallel between the first switch package and the second switch package.

7. The power converter of claim 4, wherein the commutation loop comprises a plurality of commutation loop cells connected in parallel with each other.

8. The power converter of claim 7, wherein each commutation loop cell of the plurality of commutation loop cells comprises a subset of the first plurality of capacitors and a subset of the second plurality of capacitors, each subset being connected between the first switch package and the second switch package.

9. The power converter of claim 7, wherein the plurality of commutation loop cells comprises six or more commutation loop cells connected in parallel with each other.

10. The power converter of claim 1, wherein the power converter is a capacitively-isolated Ćuk converter (CIĆC).

11. The power converter of claim 10, wherein the CIĆC is implemented in a coaxial converter cell.

12. The power converter of claim 1, wherein the power converter is configured to operate in a plurality of subintervals, the plurality of subintervals comprising power inversion, rectification, and zero-voltage switching (ZVS).

13. The power converter of claim 1, wherein the first switch package and the second switch package each comprise six or more dies connected in parallel with each other.

14. A power converter, comprising:
a plurality of cells configured to convert a first direct current (DC) voltage to a second DC voltage, an individual cell of the plurality of cells comprising:
a first switch package and a second switch package for converting the first DC voltage to the second DC voltage, the first switch package and the second switch package electrically connected between a voltage source and a load; and
an input inductor electrically connected to the first switch package and an output inductor electrically connected to the second switch package, wherein:
input ports of each of the plurality of cells are electrically connected in series; and
output ports of each of the plurality of cells are electrically connected in parallel.

15. The power converter of claim 14, wherein the individual cell further comprises:
a first capacitor package electrically connected between the input inductor and the output inductor; and
a second capacitor package electrically connected between the first switch package and the second switch package.

16. The power converter of claim 15, wherein:
the first capacitor package comprises a first plurality of capacitors connected in parallel; and
the second capacitor package comprises a second plurality of capacitors connected in parallel.

17. The power converter of claim 16, wherein a commutation loop of the individual cell comprises an electrical connection between the first capacitor package, the second capacitor package, the first switch package, and the second switch package.

18. The power converter of claim 17, wherein the commutation loop comprises a plurality of commutation loop cells connected in parallel with each other.

19. The power converter of claim 18, wherein each commutation loop cell of the plurality of commutation loop cells comprises a subset of the first plurality of capacitors and a subset of the second plurality of capacitors, each subset being connected between the first switch package and the second switch package.

20. The power converter of claim 14, wherein the plurality of cells is packaged coaxially as a part of a coaxial semiconductor package.
